(19) United States
(12) Patent Application Publication
(10) Pub. No.: US 2013/0084359 A1
(43) Pub. Date: Apr. 4, 2013

(54) FERMENTED BEVERAGE AND METHOD OF PRODUCTION

(71) Applicant: Ann Covalt, Nyack, NY (US)

(72) Inventor: Ann Covalt, Nyack, NY (US)

(21) Appl. No.: 13/632,790

(22) Filed: Oct. 1, 2012

Related U.S. Application Data
(60) Provisional application No. 61/540,925, filed on Sep. 29, 2011.

(51) Int. Cl. C12C 12/00; C12C 7/00; C12C 11/11

(52) U.S. Cl. 426/16; 426/592

(57) ABSTRACT

The present disclosure includes a fermented beverage. The fermented beverage includes water, barley, wheat, hops, yeast, goji berries and jujube fruit. The method of the present disclosure is directed to a method of producing a fermented beverage.

### CROSS REFERENCE TO RELATED APPLICATIONS

The present application claims benefit of U.S. Provisional Application No. 61/540,925 filed on Sep. 29, 2011, the contents of all of which are incorporated herein by reference.

### FIELD OF THE DISCLOSURE

The disclosure relates generally to the field of fermented beverages. More specifically, the present disclosure is directed to a fermented beverage that aids in the health of a consumer.

### BACKGROUND OF THE DISCLOSURE

Fermented beverages have been produced commercially for about 150 years, using a similar process throughout. Fermented beverages all ferment carbohydrates present in cereal grains, such as barley. These carbohydrates are not degraded by the glycolytic enzymes in yeast cells. To allow the yeast to degrade the cereal grains, the grains are malted. During the malting process, the cereal seeds are allowed to geminate until they form the appropriate enzymes that can be degraded by the yeast cells. The germination is stopped by a controlled heating, the malt now contains enzymes such as alpha amylase and maltase that are capable of being broken down.

Next, a “wort” is prepared by mixing the malt with water and mashing. The mashing allows the enzymes to break down the cereal polysaccharides into simple sugars that are soluble. The solid matter is removed and the liquid wort is boiled with hops to add flavor. The yeast cells are then added. In the presence of oxygen, the yeast cells grow and reproduce, eventually fermenting sugars into ethanol and carbon dioxide. After a period of time the fermentation reaches a predetermined point and the beverage is ready for consumption.

This process flow is used in nearly all typical fermented beverages and results in various products with various flavors. The fermented beverage product is typically viewed as having a detrimental health effect. The typical fermented beverage is viewed as a contributor to cardiovascular disease, malabsorption, pancreatitis, liver diseases and some cancers. A fermented beverage that aids in the health of a consumer is desirable.

Embodiments of the present application provide a method that addresses the above and other issues.

### SUMMARY OF THE DISCLOSURE

The present disclosure is directed to a fermented beverage and processes of producing a fermented beverage.

### BRIEF DESCRIPTION OF THE DRAWINGS

The present invention will be better understood by reference to the following drawings of which:

FIG. 1 is a schematic flow diagram of the fermented beverage production process of the present application.

### DETAILED DESCRIPTION

The fermented beverage of the present disclosure provides a beneficial health result in a consumer. The fermented beverage of the present disclosure includes ingredients used during a typical brewing process, those ingredients including water, barley, wheat, hops and yeast. But, the fermented beverage of the present disclosure also includes additives such as goji berries, jujube fruit and optionally orange fruit, clove, jasmine and green tea leaves.

The combination of these additives enhances the health benefits of these additives separately. Goji berries, or Gou Qi Zi nourishes the liver, lung and kidney. By nourishing the liver blood it brightens the eyes, tonifies kidney yin while also tonifying kidney yang. Some of the beneficial components of the goji berries are betaine, carotene, physalien, thiamine, riboflavin, vitamins C and B-sitosterol and linoleic acid. Pharmacological and clinical research has shown that goji berries have an effect on lipid metabolism and that ingestion over a period of time causes an increase in serum and liver phospholipids.

Jujube fruit, or Da Zao, tonifies the spleen, augments Qi and nourishes the blood. Jujube fruit also harmonizes and moderates the properties of other herbs. Beneficial ingredients of the jujube fruit include, but are not limited to vitamin A, vitamin B2, vitamin C, calcium phosphorous and iron. Pharmacological and clinical research has shown that goji berries have beneficial effects on the treatment of hepatic disease from hepatitis and cirrhosis with high transaminase levels.

Oranges, including the Chen Pi or pericarpium citri reticulatae, regulates the body's Qi and helps prevent stagnation by preventing the cloying nature of tonifying herbs. It aids in lung, spleen and stomach health.

Cloves, or ding xiang, can be used to increase hydrochloric acid in the stomach and to improve peristalsis. Cloves enter the kidney, spleen and stomach meridians, direct stomach qi downward and fortify the kidney yang.

Jasmine offers a pleasant odor and taste, and operates an astringent, is anti-bacterial and anti-viral.

Green tea leaves contain catechins, tocopherols, ascorbic acid and various minerals.

The combination of goji berry, jujube fruit and optionally orange fruit, clove, jasmine and green tea leaves, has a synergistic relationship. Both goji berries and jujube fruit are tonifying the blood and Qi. The two components are complemented by the regulatory effect of the orange. There is a flow of tonification without stagnation. The damaging effects of ethanol are lessened by the therapeutic affects and properties of these components.

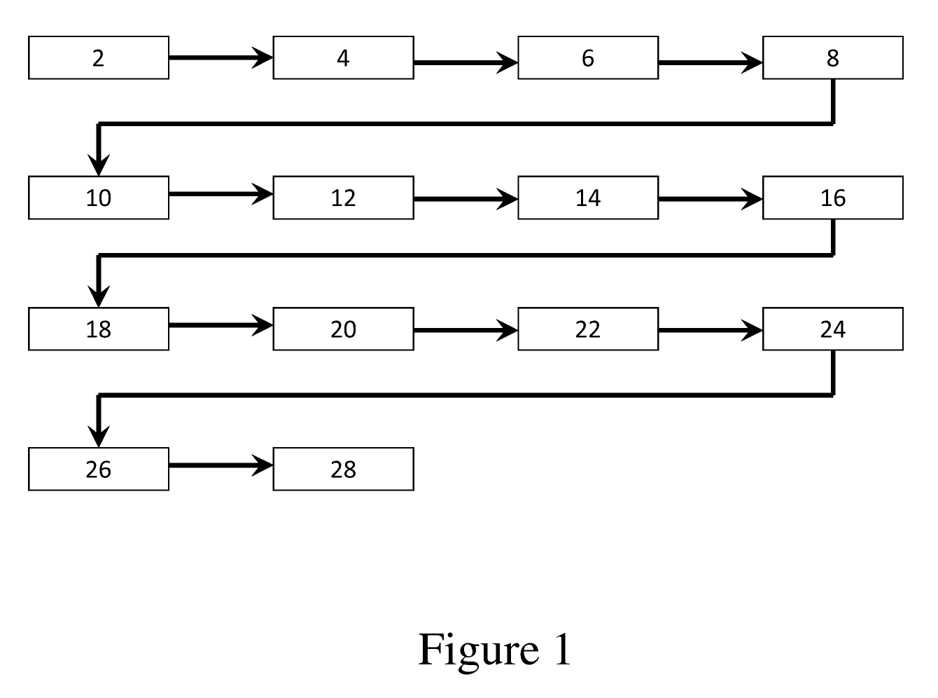

The method of making a fermented beverage including these components includes several steps, each of these steps are described below and illustrated in FIG. 1.

Initially, water and grain are added to a vessel, in a water and grain addition step 2, at about a ratio of 1.2-0.4 quarts per pound of grain. The water to grain ratio can be adjusted further to about 1.0-0.6 quarts per pound of grain, as desired. The grain can be any suitable grain.

Next, after water and grain addition step 2, the water and grain are heated to an elevated temperature of about 120-140° F. for about 15-30 minutes in a first heating step 4. The temperature can be adjusted further to about 125-135° F. and the time can be adjusted to about 18-25 minutes, as desired.

Next, after first heating step 4, more water was added to increase the water to grain ratio to about 1.1-1.5 quarts of water per pound of grain and the temperature was increased to about 140-160° F. for about 40-90 minutes in further water addition step 6. The ratio can be adjusted further to about 1.2-1.4 quarts of water per pound, as desired. Further, the temperature can be adjusted to about 145-155° F. and the time can be from about 50-75 minutes, as desired.

Next, after further water addition step 5, the water and grain were increased in temperature to a mashout temperature of about 155-170° F. in a second heating step 8. The mashout temperature can be reached by providing external heat and can also be reached by adding sparge water at a temperature of about 165-185° F. to the water and grain, to reach a mashout temperature. Throughout the above heating and grain addition steps, the water and grain react to form a liquid wort.

Next, after second heating step 8, the liquid wort is removed from the solid grains by a suitable filtration process in first filtration step 10 to form a first liquid. The first filtration step 10 removes substantially all of the solid portions of the grain from the first liquid.

Next, after the first filtration step 10, hops are added to the first liquid in hop addition step 12. The hops can be in a pellet form or may be in a loose form. The hops can be chosen to have alpha acids that are not too high or too bitter to complement the subsequently added additives. Next, after hop addition step 12, the hops and the first liquid are boiled together for about 15-40 minutes in hops and first liquid boiling step 14. The boiling time of the first liquid and the hops can be adjusted to about 20-35 minutes, as desired.

Next, after hops and first liquid boiling step 14, the additives, goji berries, jujube fruit and optionally orange fruit, clove, jasmine and green tea leaves, are introduced to the already boiling hops and first liquid in hops, additives and first liquid boiling step 16. The combination of additives, hops and liquid wort are boiled for about 15-40 minutes. The boiling time of the liquid wort, hops and additives can be adjusted to about 20-35 minutes, as desired.

Next, after hops, additives and first liquid boiling step 16, the hops and additives are removed from the liquid in second filtration step 18 to form a second liquid. Second filtration step 18 removes substantially all of the solid portions of the hops and substantially all of the solid portions of the additives from the second liquid.

Next, after second filtration step 18, about 700-900 mL of yeast are added to the second liquid and the second liquid is oxygenated in yeast addition step 20. The second liquid can be oxygenated for any suitable length of time, from about 1 minute to about 100 minutes. The yeast can be a lager type yeast and can also be an ale type yeast and a limbic type yeast.

Next, after yeast addition step 20, the second liquid is allowed to primarily ferment at a suitable temperature during primary fermentation step 22. As an example, if a lager type yeast is used, primary fermentation can occur at a temperature of about 38-60° F. If an ale type yeast is used, primary fermentation can occur at a temperature of about 60-80° F. The amount of time the second liquid is spent in primary fermentation can be between about 3-15 days. The amount of time the second liquid is spent in primary fermentation can be adjusted to about 4-10 days, if desired.

Next, after primary fermentation step 22, the second liquid begins a secondary fermentation period in secondary fermentation step 24. The second fermented liquid can be removed from the vessel it has been stored in or can remain in the same vessel. Depending on the type of yeast used, secondary fermentation can occur at a temperature of about 38-60° F. for lager type yeast is sued while secondary fermentation can occur at a temperature of about 60-80° F. if ale type yeast is used. Secondary fermentation can occur for about 4-50 days. The amount of time the second liquid is spent in secondary fermentation can be adjusted to about 5-25 days, as desired.

Next, after secondary fermentation step 24, a third liquid is formed. The third liquid is then carbonated in carbonation step 26. Next, after carbonation step 26, the carbonated third liquid is placed into bottles, cans, kegs or other suitable storage vessels during packaging step 28.

As an example the above described method can be used to produce about 15 gallons of fermented beverage. This production can be scaled up or down depending on the desired quantity of beverage.

What is claimed is:

1. A fermented beverage comprising:
water;
barley;
wheat;
hops;
yeast;
goji berries; and
jujube fruit.

2. The fermented beverage of claim 1, further comprising an additive selected from the group consisting of orange fruit, clove, jasmine, green tea leaves and combinations thereof.

3. The fermented beverage of claim 2, wherein the orange fruit is chen pi.

4. The fermented beverage of claim 1, further comprising additional carbon dioxide.

5. A fermented beverage consisting of:
water;
barley;
wheat;
hops;
yeast;
carbon dioxide;
goji berries; and
jujube fruit.

6. The fermented beverage of claim 5 further comprising an additive selected from the group consisting of orange fruit, clove, jasmine, green tea leaves and combinations thereof.

7. A method of producing a fermented beverage, the method comprising the steps of:
a. adding water and grain into a vessel;
b. heating the water and grain in the vessel;
c. adding additional water to the vessel;
d. heating the water and grain in the vessel;
e. removing substantially all of the solid portions of the grain from the first liquid in the vessel;
f. adding hops to the first liquid in the vessel
g. boiling the hops and first liquid in the vessel;
h. adding additives into the boiling hops and first liquid in the vessel;
i. removing substantially all of the solid portions of the hops and substantially all of the solid portions of the additives from the first liquid in the vessel to form a second liquid;
j. adding yeast and oxygen to the second liquid;
k. fermenting the second liquid for a period of time to form a third liquid;
l. carbonating the third liquid; and
m. packaging the third liquid in a suitable package.

8. The method of claim 7 wherein the additives are goji berry and jujube fruit.

9. The method of claim 7 wherein the additives are goji berry, jujube fruit and orange fruit.

10. The method of claim 9 wherein the orange fruit is chen pi.

11. The method of claim 7 wherein the additives are selected from the group consisting of goji berry, jujube fruit, orange fruit clove, jasmine, green tea leaves and combinations thereof.
